(19) United States
(12) Patent Application Publication
(10) Pub. No.: US 2012/0124229 A1
(43) Pub. Date: May 17, 2012

(54) METHODS AND APPARATUS OF INTEGRATING DEVICE POLICY AND NETWORK POLICY FOR ARBITRATION OF PACKET DATA APPLICATIONS

(75) Inventors: Debesh Kumar Sahu, Hyderabad (IN); Keyur C. Shah, Mumbai (IN); Sivaramakrishna Veerepalli, San Diego, CA (US); Bryan R. Cook, San Diego, CA (US)

(73) Assignee: QUALCOMM Incorporated, San Diego, CA (US)

(21) Appl. No.: 13/294,120

(22) Filed: Nov. 10, 2011

Related U.S. Application Data
(60) Provisional application No. 61/413,276, filed on Nov. 12, 2010.

(51) Int. Cl. G06F 15/16

(52) U.S. Cl. 709/228

(57) ABSTRACT

An apparatus or method integrates device policy and network policy in order to arbitrate a priority between packet data applications or services for a data connection. In response to a request, a data connection to a wireless network is established for a first application of a first type of application or service if no data session is in progress or if a second application of a second type of application or service can share an existing data session. A hybrid arbitrator performs hybrid arbitration between the first application and the second application in response to determining that the first type and the second type cannot share the existing data session, either based upon a network policy that specifies a difference in priority between the first type and the second type, or based upon a device policy if the network policy does not specify a difference in priority.

### CLAIM OF PRIORITY UNDER 35 U.S.C. §119

The present Application for Patent claims priority to Provisional Application No. 61/413,276 entitled “METHODS AND APPARATUS OF INTEGRATING DEVICE POLICY AND NETWORK POLICY FOR ARBITRATION OF PACKET DATA APPLICATIONS” filed Nov. 12, 2010, and assigned to the assignee hereof and hereby expressly incorporated by reference herein.

### BACKGROUND

The present disclosure relates generally to communication, and more specifically to techniques for prioritizing access for applications or services to a wireless packet data connection.

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, and orthogonal frequency division multiple access (OFDMA) systems. Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

Universal Mobile Telecommunications System (UMTS) is one of the third-generation (3G) cell phone technologies. UTRAN, short for UMTS Terrestrial Radio Access Network, is a collective term for the Node-B's and Radio Network Controllers which make up the UMTS radio access network. This communications network can carry many traffic types from real-time Circuit Switched to IP based Packet Switched. The UTRAN allows connectivity between the UE (user equipment) and the core network. The RNC provides control functionalities for one or more Node Bs. A Node B and an RNC can be the same device, although typical implementations have a separate RNC located in a central office serving multiple Node B's. Despite the fact that they do not have to be physically separated, there is a logical interface between them known as the Iub. The RNC and its corresponding Node Bs are called the Radio Network Subsystem (RNS). There can be more than one RNS present in an UTRAN.

CDMA2000 (also known as IMT Multi Carrier (IMT MC)) is a family of 3G mobile technology standards, which use CDMA channel access, to send voice, data, and signaling data between mobile phones and cell sites. The set of standards includes: CDMA2000 1X, CDMA2000 EV-DO Rev. 0, CDMA2000 EV-DO Rev. A, and CDMA2000 EV-DO Rev. B. All are approved radio interfaces for the ITU's IMT-2000. CDMA2000 has a relatively long technical history and is backward-compatible with its previous 2G iteration IS-95 (cdmaOne).

CDMA2000 1X (IS-2000), also known as 1x and 1xRTT, is the core CDMA2000 wireless air interface standard. The designation “1x”, meaning 1 times Radio Transmission Technology, indicates the same RF bandwidth as IS-95: a duplex pair of 1.25 MHz radio channels. 1xRTT almost doubles the capacity of IS-95 by adding 64 more traffic channels to the forward link, orthogonal to (in quadrature with) the original set of 64. The 1X standard supports packet data speeds of up to 153 kbps with real world data transmission averaging 60-100 kbps in most commercial applications. IMT-2000 also made changes to the data link layer for the greater use of data services, including medium and link access control protocols and Quality of Service (QoS). The IS-95 data link layer only provided “best effort delivery” for data and circuit switched channel for voice (i.e., a voice frame once every 20 ms).

CDMA2000 1xEV-DO (Evolution-Data Optimized), often abbreviated as EV-DO or EV, is a telecommunications standard for the wireless transmission of data through radio signals, typically for broadband Internet access. It uses multiplexing techniques including code division multiple access (CDMA) as well as time division multiple access (TDMA) to maximize both individual user's throughput and the overall system throughput. It is standardized by 3rd Generation Partnership Project 2 (3GPP2) as part of the CDMA2000 family of standards and has been adopted by many mobile phone service providers around the world, particularly those previously employing CDMA networks.

3GPP LTE (Long Term Evolution) is the name given to a project within the 3rd Generation Partnership Project (3GPP) to improve the UMTS mobile phone standard to cope with future requirements. Goals include improving efficiency, lowering costs, improving services, making use of new spectrum opportunities, and better integration with other open standards. The LTE system is described in the Evolved UTRA (EUTRA) and Evolved UTRAN (EUTRAN) series of specifications.

In addition to voice services, mobile devices are increasingly being used for data packet services such as Internet Protocol (IP) web browsing, and data burst messages such as Short Message Service (SMS) text messaging and Media Message Service (MMS) messaging, and Location Based Services (LBS), etc. Often, such LBS applications can share an existing data connection to maintain guidance without interfering with other data packet services.

One way in which multiple data packet services are managed is by provisioning a mobile device with a subscriber identification. In order for handsets to interface with subscriber networks, subscriber identification carried by the handset is required. For example, a Subscriber Identity Module (SIM) on a removable SIM card securely stores the service-subscriber key for identification purposes on mobile telephony devices (such as mobile phones and computers). The SIM card allows users to change phones by simply removing the SIM card from one mobile phone and inserting it into another mobile phone or broadband telephony device.

A SIM card contains its unique serial number, International Mobile Subscriber Identifier (IMSI) of the mobile device, security authentication and ciphering information, temporary information related to the local network, a list of the services the user has access to and two passwords (Personal Identification Number (PIN) for usual use and Personal Unblocking Key (PUK) for unlocking).

Each SIM card stores a unique International Mobile Subscriber Identity (IMSI), of this number format: (a) The first 3 digits represent the Mobile Country Code (MCC); (b) The next two or three digits represent the Mobile Network Code (MNC); (c) The remaining digits represent the Mobile Station Identification (MSID) number; and (d) A SIM card also has an Integrated Circuit Card Identification (ICC-ID) number.

A virtual SIM is a mobile phone number provided by a mobile network operator that does not require a SIM card to terminate phone calls on a user's mobile phone.

A RUIM card (also R-UIM) or Removable User Identification Module, is a removable smart card for cellular phones made for the CDMA2000 network. The R-UIM is essentially the 3GPP/ETSI SIM for CDMA2000 systems—which are both based on the Integrated Circuit Card (ICC). The RUIM card holds a user's personal information such as name and account number, cell phone number, phone book, text messages and other settings.

A CDMA Subscriber Identity Module (CSIM) is an application that runs on the newer smart card known as the Universal Integrated Circuit Card (UICC). The UICC can store a CSIM application, USIM application, SIM and/or R-UIM and can be used to enable operation with cellular networks globally. UICC carries the Application Directory Files (ADF) of CSIM and USIM and others. SIM and R-UIM are legacy cards based on ICC. Both SIM and R-UIM can be added on to the UICC but not as an ADF but as a DF (Directory File). The UICC which can carry a CSIM application allows users to change phones by simply removing the smart card from one mobile phone and inserting it into another mobile phone or broadband telephony device.

An operator can provide different services such as a Wireless Access Point (WAP), a Multimedia Messaging Service (MMS), and a virtual machine platform (e.g., JAVA, BREW, etc.). The operator may have different settings for such services. For instance, settings can refer to a profile with an associated priority. Alternatively, the setting can be merely a username or a connection name, etc., without a priority. Typically the settings of an operator are stored in a SIM/RUIM/USIM card or are stored in device memory for non-card based devices. The device needs to use the appropriate setting when a particular service/application is used. The settings can be used for various operator purposes, such as the following illustrative and not all-inclusive purposes:

(a) To distinguish different kinds of data calls for billing purposes and to find usage statistics.

(b) To route data traffic differently for different kinds of applications. Some applications may be routed to a private network of a carrier, while others may be routed to the public Internet.

(c) To control different data applications when run simultaneously through application priority control.

Increasingly, high-end devices such as so-called smart phones are capable of connection concurrency between multiple applications or services. In addition to whether each device has the requisite hardware for concurrency, different mobile devices can have different device policies for concurrency, such as at an application layer. Further, an operator can impose network policies, such as policies provisioned at a communication modem layer.

Operators provide different profiles and priority (e.g., stored in SIM/RUIM/device memory) for different data applications/services for a variety of reasons such as for different billing, for routing different data traffic inside a backend network, etc. Packet Data profiles are widely used in various wireless technologies. For example, Packet Date profiles may include 3GPD profiles as defined in “3GPP2 C.S0023 Rev D/C.S0065 Rev A RUIM specs.” Also, a device Operating System may have its own priority for Packet Data Applications.

Thus, a question remains of what the device behavior should be when a second application comes up which needs to access the network when a first application is using the network. For instance, if only one among multiple applications can be given access to the network at any single point in time, the device needs to make a decision as to which application gets priority for the connection.

### SUMMARY

The following presents a simplified summary in order to provide a basic understanding of some aspects of the disclosed innovation. This summary is not an extensive overview and is intended to neither identify key or critical elements nor delineate the scope of such aspects. Its purpose is to present some concepts of the described features in a simplified form as a prelude to the more detailed description that is presented later.

In one aspect, the present disclosure provides a method for integrating device policy and network policy for arbitrating data connection priority between packet data applications or services. The method includes receiving a request for a data connection to a wireless network from a first application of a first type of application or service. The method includes setting up a data session for the first application in response to determining that no other data session is in progress. The method also includes sharing an existing data session of a second application of a second type of application or service in response to determining that the first type and the second type can share the existing data session. The method further includes performing hybrid arbitration between the first application and the second application in response to determining that the first type and the second type cannot share the existing data session, including selecting the first application or the second application to use the data connection based on a network policy in response to determining that the network policy specifies a difference in priority between the first type and the second type of application or service, and selecting the first application or the second application to use the data connection based on a device policy in response to determining that the network policy does not specify a difference in priority between the first type and the second type of application or service.

In another aspect, the present disclosure provides at least one processor for integrating device policy and network policy for arbitrating data connection priority between packet data applications or services. A first module receives a request at a user equipment for a data connection to a wireless network from a first application of a first type of application or service. A second module sets up a data session for the first application in response to determining that no other data session is in progress. A third module shares an existing data session of a second application of a second type of application or service in response to determining that the first type and the second type can share the existing data session. A fourth module performs hybrid arbitration between the first application and the second application in response to determining that the first type and the second type cannot share the existing data session, including selecting the first application or the second application to use the data connection based on a network policy in response to determining that the network policy specifies a difference in priority between the first type and the second type of application or service, and selecting the first application or the second application to use the data connection based on a device policy in response to determining that the network policy does not specify a difference in priority between the first type and the second type of application or service.

In an additional aspect, the present disclosure provides a computer program product for integrating device policy and network policy for arbitrating data connection priority between packet data applications or services. A non-transitory computer- readable storage medium includes stored sets of code. A first set of code causes a computer to receive a request at a user equipment for a data connection to a wireless network from a first application of a first type of application or service. A second set of code causes the computer to set up a data session for the first application in response to determining that no other data session is in progress. A third set of code causes the computer to share an existing data session of a second application of a second type of application or service in response to determining that the first type and the second type can share the existing data session. A fourth set of code causes the computer to perform hybrid arbitration between the first application and the second application in response to determining that the first type and the second type cannot share the existing data session, including selecting the first application or the second application to use the data connection based on a network policy in response to determining that the network policy specifies a difference in priority between the first type and the second type of application or service, and selecting the first application or the second application to use the data connection based on a device policy in response to determining that the network policy does not specify a difference in priority between the first type and the second type of application or service.

In a further aspect, the present disclosure provides an apparatus for integrating device policy and network policy for arbitrating data connection priority between packet data applications or services. The apparatus comprises means for receiving a request at a user equipment for a data connection to a wireless network from a first application of a first type of application or service. The apparatus comprises means for setting up a data session for the first application in response to determining that no other data session is in progress. The apparatus comprises means for sharing an existing data session of a second application of a second type of application or service in response to determining that the first type and the second type can share the existing data session. The apparatus comprises means for performing hybrid arbitration between the first application and the second application in response to determining that the first type and the second type cannot share the existing data session, including means for selecting the first application or the second application to use the data connection based on a network policy in response to determining that the network policy specifies a difference in priority between the first type and the second type of application or service, and means for selecting the first application or the second application to use the data connection based on a device policy in response to determining that the network policy does not specify a difference in priority between the first type and the second type of application or service.

In yet another aspect, the present disclosure provides a user apparatus for integrating device policy and network policy for arbitrating data connection priority between packet data applications or services. A computing platform receives a request at a user equipment for a data connection to a wireless network from a first application of a first type of application or service. A transceiver sets up a data session for the first application in response to determining that no other data session is in progress. The transceiver further shares an existing data session of a second application of a second type of application or service in response to the computing platform further determining that the first type and the second type can share the existing data session. A hybrid arbitrator performs hybrid arbitration between the first application and the second application in response to determining that the first type and the second type cannot share the existing data session, including selecting the first application or the second application to use the data connection based on a network policy in response to determining that the network policy specifies a difference in priority between the first type and the second type of application or service, and selecting the first application or the second application to use the data connection based on a device policy in response to determining that the network policy does not specify a difference in priority between the first type and the second type of application or service.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 depicts a schematic block diagram of a communication system in which a device performs hybrid arbitration for a data connection between applications or services with reference to both device and network policies.

FIG. 2 depicts a flow diagram of a methodology for performing hybrid arbitration for a data connection between applications or services with reference to both device and network policies.

FIG. 3 depicts a block diagram of an application layer and modem layer of a device collaboratively performing hybrid arbitration.

FIG. 4 depicts a flow diagram of a methodology for performing hybrid arbitration with a preference given to network policy.

FIG. 5 depicts a block diagram of a user equipment apparatus having logical grouping of electrical components for arbitrating data connection priority between packet data applications or services.

FIG. 6 depicts schematic block diagram of an aspect of a user equipment as described herein operating in a 3GPP and 3GPP2 communication system.

FIG. 7 depicts a block diagram of an aspect of a user equipment for integrating device policy and network policy for arbitrating data connection priority between packet data applications or services.

### DETAILED DESCRIPTION

Methods and apparatus are disclosed for integrating device policy and network policy in order to arbitrate priority between packet data applications or services for a data connection. Rather than arbitrating using only a network policy or a device policy, the described aspects incorporate a hybrid approach. In an aspect, for example, a hybrid arbitration algorithm uses both the settings (e.g., network/operator policy) from a card loaded into a device, and also settings (e.g., device policy) from a memory on the device, in such a way so that intentions of both are met. In one aspect, for example, the network policy is given preference with the device policy being used when the network policy fails to prioritize contending applications or services. If the device policy also fails to prioritize contending applications or services, then the most recently launched application or service is allowed to connect. Additionally, in an aspect, a shared connection for the contending applications or services is allowed, e.g. if indicated by the network policy. In another aspect, service type mapping between the device policy and network policy can occur in advance in order to be prepared for arbitration.

Currently there are two approaches being implemented by different device vendors, either using network (e.g., operator) policy or using device policy. Each approach has problems.

When network policy is used, conventional approaches in arbitrating contention between two or more applications or services to get the data session give consideration to network backend needs or revenue generation potential. Many applications are not given a relative priority, if not a highest or lowest priority.

Thus, generally, an operator configures high priority for some specific applications that need to get a data connection as soon as possible based on their backend network setup. For example, a Multimedia Messaging Service (MMS) is often given high priority in order to allow a device to setup a data connection to download content from a corresponding Multimedia Messaging Service Center (MMSC) server when the device receives a notification. Operators may give priority to setup the data connection for such an application over some other applications, such as a virtual machine platform (e.g., Binary Runtime Environment for Wireless (BREW) from Qualcomm Incorporated).

As another example, when a user would like to setup a voice call by Voice over Internet Protocol (VoIP), the user can have an expectation for the setup to take priority. Thus, the device should give VoIP a higher priority than other applications or services, even MMS.

In addition, in an aspect, the device should give priority for a Bearer Independent Protocol (BIP) data connection to a service program of a UICC card during runtime.

Further, in an aspect, tethered calls can be given a higher priority by an operator over virtual machine services due to higher revenue generation.

Similarly, a few specific applications can be given a lowest priority by network policy so that other applications can get a data connection. For example, an “Always ON” connection is a service which gets started when a device powers on. Such an application cannot be given a high priority without precluding lower priority applications from being launched. Other than assigning highest or lowest priorities to specific applications or services, operators generally do not prioritize other applications or services, giving them the same relative priority if such applications or services are not relevant to the operator.

For example, applications or services may be given the same priority due to equal revenue potential and/or equal urgency considerations. However, operators may not intend for such services to necessarily share a data connection. If relying only on network policy, however, then sharing the data connection between two applications can be an inadvertent or undesirable result.

In another aspect, an operator can provision a device with separate data profiles, albeit with the same priority, for the purpose of treating the corresponding applications or services differently. In such aspects, sharing a data connection can defeat the intent of the operator. To avoid this situation, an operator can be forced to assign a unique priority to each kind of application or service.

Moreover, when arbitrating contention between applications or services based on device policy rather than network policy, some device operating systems provide their own priorities for data applications or services. If the device operating system performs arbitration based only device policy, then network policy is overridden. Often, this is unacceptable to operators.

With high-end smart phones coming to market with different High-Level Operating Systems (HLOS), increasingly devices can have their own arbitration logic in their application/platform layer. The problem is that if an operator wants to have a particular behavior, the device policy will override the network policy since devices operating in an open market configuration will not cater to operator-specific requirements. Thus, operator priority configurations will be ignored.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

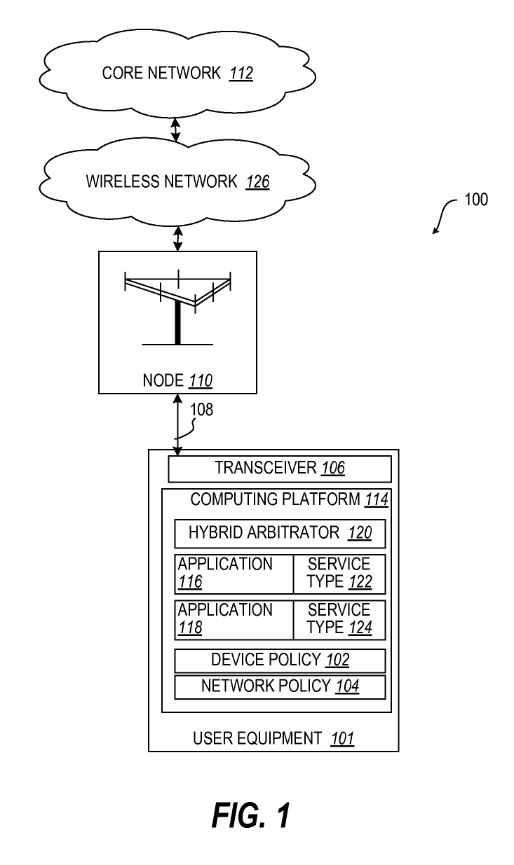

In FIG. 1, in a communication system 100, a user apparatus, depicted as user equipment 101, is configured to integrate device policy 102 and network policy 104 for arbitrating priority for a data connection between packet data applications or services. A transceiver 106 establishes a packet data connection 108 with a node 110 to communicate with a core network 112. A computing platform 114 launches a first application 116 and may additionally be executing a second application 118 that is using the packet data connection 108. A hybrid arbitrator 120 of the user equipment 101 maps application types or service types of the applications or services according to the device policy 102 and network policy 104. For example, the first application 116 is depicted as being of a first type 122 of application or service and the second application 118 is depicted as being of a second type 124 of application or service. The hybrid arbitrator 120 arbitrates a contention for the packet data connection 108 between the first application 116 and the second application 118 based upon the mapping between the device policy 102 and the network policy 104.

In an exemplary aspect, the computing platform 114 receives a request at the user equipment 101 for a data connection 108 to a wireless network by the first application 116 of the first type 122 of application or service. In one aspect, the transceiver 106 sets up a data session, e.g. packet data connection 108, for the first application 116 in response to determining that no other data session is in progress.

In another aspect, the transceiver 106 can share an existing data session of the second application 118 of the second type 124 of application or service, e.g. packet data connection 108, in response to the computing platform 114 determining that the first type 122 and the second type 124 can share the existing data session.

In another aspect, however, the hybrid arbitrator 120 performs hybrid arbitration between the first application 116 and the second application 118 in response to the computing platform 114 determining that the first type 122 and the second type 124 cannot share the existing data session, e.g. packet data connection 108. For example, hybrid arbitrator 120 can operate to select the first application 116 or the second application 118 to use the existing data session based on the network policy 104 in response to determining that the network policy 104 specifies a difference in priority between the first type 122 and the second type 124 of application or service. For instance, hybrid arbitrator 120 can select the one of the first application 116 or the second application 118 having the relatively higher priority according to the network policy 104. Alternatively, the hybrid arbitrator 120 can select the first application 116 or the second application 118 to use the existing data session based on the device policy 102 in response to determining that the network policy 104 does not specify a difference in priority between the first type 122 and the second type 124 of application or service. For instance, hybrid arbitrator 120 can select the one of the first application 116 or the second application 118 having the relatively higher priority according to the device policy 102.

Thus, the described methods and apparatus apply a hybrid arbitration that integrates device policy and network policy to determine a priority between packet data applications or services contending for a data connection.

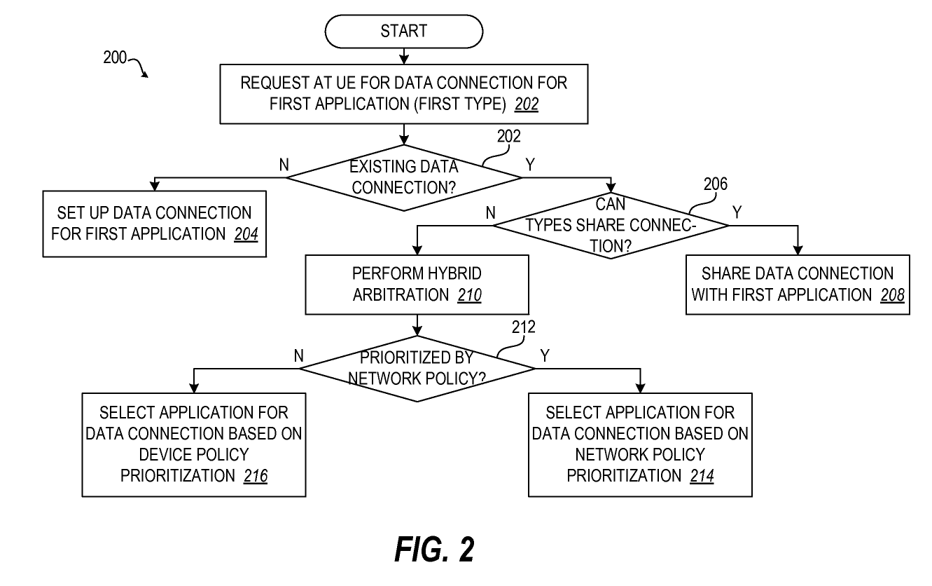

In FIG. 2, a method 200 is depicted for integrating device policy and network policy for arbitrating data connection priority between packet data applications or services. For example, method 200 may be executed by a device, such as user equipment 101 using the components described in FIG. 1. The method 200 includes receiving a request for a data connection to a wireless network from a first application of a first type of application or service (block 202). The method 200 further includes a determination as to whether a second application has an existing data connection (block 204). In block 204, the method 200 includes setting up a data session for the first application in response to determining that no other data session is in progress in block 202. Otherwise, the method 200 includes a determination as to whether the first type and the second type of application or service are compatible for sharing the existing data connection (block 206). For example, such a determination may be indicated in a network policy, and/or in a device policy. If so, the method 200 includes sharing an existing data session of the second application of the second type of application or service with the first application of the first type (block 208). If not, then the method 200 includes performing hybrid arbitration between the first application and the second application (block 210). Performing the hybrid arbitration includes determining whether a network policy specifies a difference in priority between the first type and the second type of application or service (block 212). If so, in block 212, the method 200 includes selecting the first application or the second application to use the data connection based on the network policy (block 214). For instance, the method may select the application having a relatively higher priority value according to the network policy, e.g. a policy that may be stored on a removable memory card, such as may be supplied by a network operator to operate the device on a network of the network operator. If the applications are not prioritized by network policy, then, in block 212, the method 200 includes selecting the first application or the second application to use the data connection based on the device policy (block 216). For instance, the method may select the application having a relatively higher priority value according to the device policy, e.g. a policy of a non-network operator that may be stored on a local memory, such as a non-volatile memory, on the device. Further, for example, either at block 214 or at block 216, if the selected application is the previously executing application, then the previously executing application is allowed to maintain the existing data session. Alternatively, for example, either at block 214 or at block 216, if the selected application is the newly launched application, then the existing data session for the previously executing application may be disconnected and a new data connection established for the newly launched application, or the previously executing application may be replaced with the newly executed application in using the existing data session.

In one aspect, the method 200 performs hybrid arbitration at the user equipment according to a fixed network rule that cannot be changed at the user equipment.

In another aspect, the method 200 further includes receiving a user input at the user equipment and creating a new device policy at the user equipment based upon the user input.

In a further aspect, the method 200 further includes provisioning the user equipment with the network policy, prior to performing the hybrid arbitration, from at least one of a subscriber identification storage medium or an over-the-air transmission.

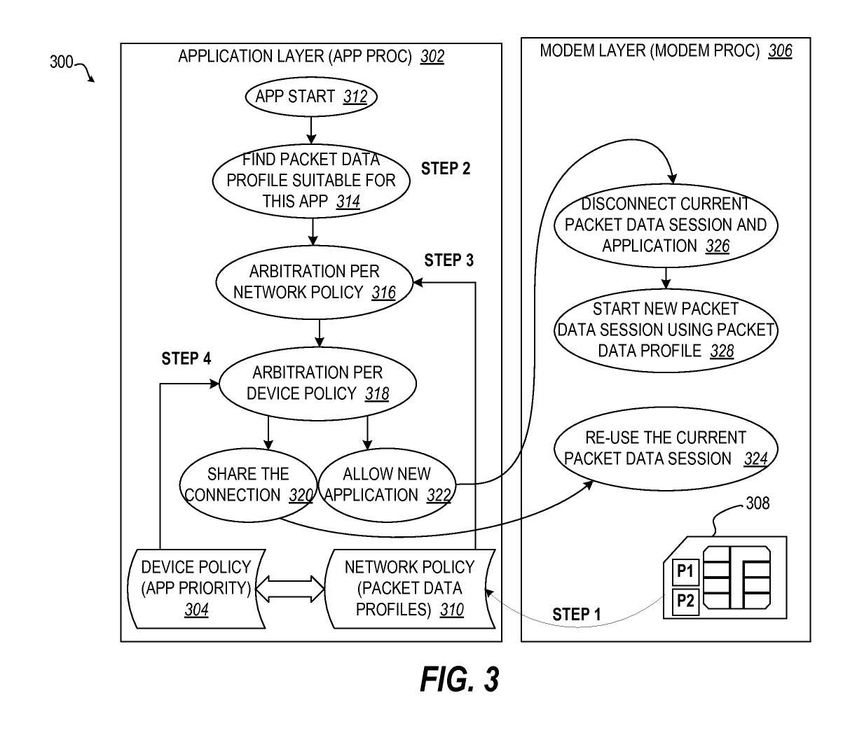

In FIG. 3, an apparatus or device 300 for wireless communication has an application (“app”) layer or app process 302 provisioned with a device policy (app priority) 304 for arbitrating for packet data connection access between multiple applications. In an aspect, apparatus or device 300 may be the same as or included within user equipment 101 (FIG. 1), with the components of user equipment 101 including the following structure and/or functions. The device 300 also has a modem layer or modem process, referred to herein as modem layer 306, provisioned with a network policy 308. For example, in this aspect, modem layer 306 is depicted as a smartcard that contains multiple profiles P1, P2. Rather than relegating usage of the device policy 304 to use (if at all) in the application layer 302 or relegating usage of the network policy 308 (if at all) in the modem layer 306, a retrieved copy 310 of network policy (packet data profiles) is brought to the application layer 302 as depicted at step 1. Thus, when an application starts (block 312), in step 2 the application layer can find a packet data profile that is suitable for the application (block 314). With reference to the retrieved copy 310 of network policy (packet data profiles) in step 3, the application layer 302 can perform arbitration per the network policy (block 316). As such, if the network policy does not dictate any relative prioritization of the application, then the device 300 will use a hybrid arbitration approach. Otherwise, the device 300 may select the priority as dictated by the network policy. In the disclosed hybrid approach, the application layer 302 at step 4 also performs arbitration per device policy (block 318).

For example, depending on the hybrid arbitration priorities and allowances for shared connections, a determination is made by the application layer 302 either to share an existing data connection (block 320) or allow the new application to connect (block 322). If the former, then the modem layer 306 re-uses the current packet data session (block 324). The modem layer 306 may also continue serving a previously-executing application by denying a data connection to the new application. Alternatively, if the application layer 302 allows the new application to connect (block 322), then the application layer 302 may disconnect a current packet data session for a previously-executing application (block 326) and start a new packet data session using a packet data profile corresponding to the newly launched application (block 328), or the application layer 302 may replace the previously-executing application with the newly launched application for using the existing data session.

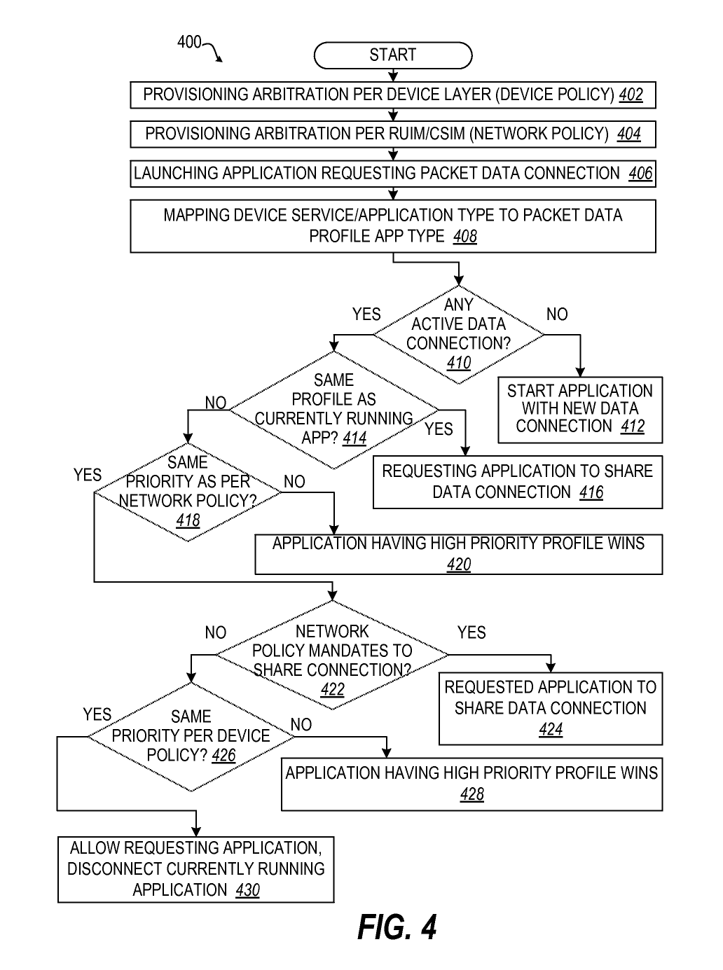

In FIG. 4, a methodology 400 is depicted for integrating device policy and network policy for arbitrating data connection priority between packet data applications or services. In block 402, a device is provisioned with arbitration per device layer (device policy). In block 404, a device is provisioned with arbitration per network policy, such as from a memory card, including a RUIM and/or CSIM or other similar cards. In block 406, the device launches an application that requests a packet data connection. In block 408, a device service/application type of the launched application is mapped to a packet data profile application type.

Additionally, methodology 400 includes making a first determination as to whether there is any active data connection (block 410). If not, the application is started with a new data connection (block 412). Otherwise, a second determination is made as to whether the same profile used for current active application may be used for running the application (block 414). If so, then the requested application can share the data connection (block 416). Otherwise, a third determination is made as to whether the same priority is accorded to the requesting application as the currently connected application, according to network policy (block 418). If not, then the application with the highest priority profile wins, e.g. obtains the right to establish (or maintain) a packet data connection (block 420). Otherwise, a fourth determination is made as to whether the network policy mandates to share the connection (block 422). If so, then the requesting application can share the data connection (block 424). Otherwise, a fifth determination is made as to whether the applications have the same priority per device policy (block 426). If not, then the application having a high priority profile wins, e.g. obtains the right to establish (or maintain) a packet data connection (block 428). Otherwise, the newly-launched, requesting application is allowed to connect and the currently executing application is disconnected (block 430).

In an exemplary aspect, the device provides an option (e.g., SHARABLE_FLAG) to operators to indicate whether to share the data session or not between two profiles with the same priority. The device reads the operator settings and policy (e.g., priorities, etc.) as well as having its own application/platform layer policies. The device maps the ServiceType of its platform layer to Operator Service Type. When the device needs to arbitrate between two applications, the device checks SHARABLE_FLAG. If the flag says YES, the device allows the new application to reuse the current data session, else the device checks the operator policy to see if the operator policy dictates a particular behavior. If so, then the device arbitrates based on that operator dictated policy and the appropriate application gets access. If the operator policy does not exist or does not define a behavior for the particular case, then the device uses the device policy and determines which application to allow access.

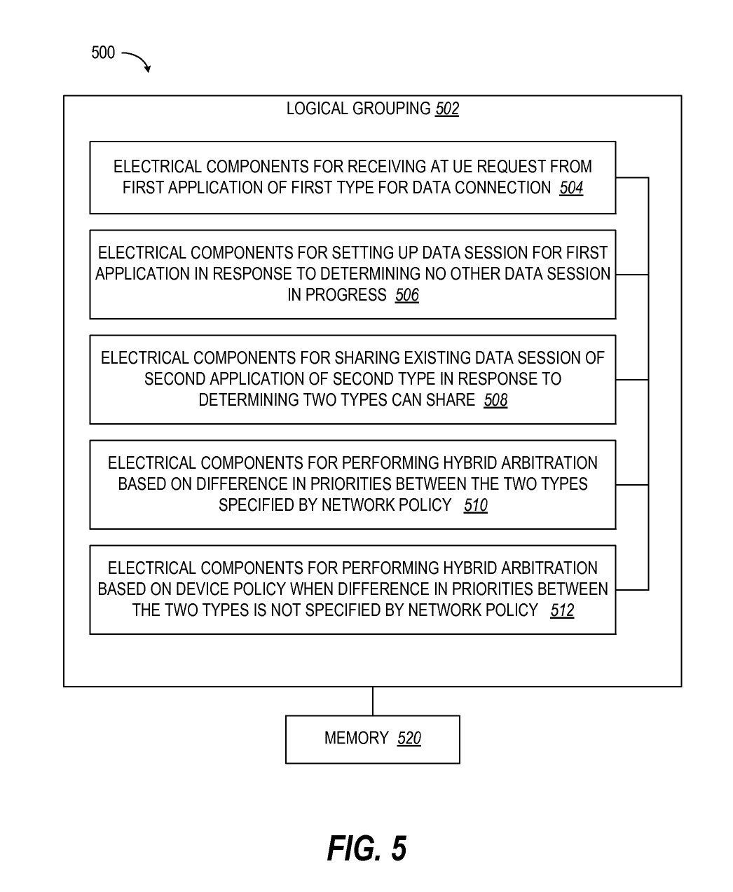

With reference to FIG. 5, illustrated is a system 500 for integrating device policy and network policy for arbitrating data connection priority between packet data applications or services. For example, system 500 can reside at least partially within user equipment (UE). It is to be appreciated that system 500 is represented as including functional blocks, which can be functional blocks that represent functions implemented by a computing platform, processor, software, or combination thereof (e.g., firmware). System 500 includes a logical grouping 502 of electrical components that can act in conjunction. For instance, logical grouping 502 can include an electrical component 504 for receiving a request at a user equipment for a data connection to a wireless network from a first application of a first type of application or service. Moreover, logical grouping 502 can include an electrical component 506 for setting up a data session for the first application in response to determining that no other data session is in progress. In addition, logical grouping 502 can include an electrical component 508 for sharing an existing data session of a second application of a second type of application or service in response to determining that the first type and the second type can share the existing data session. Further, logical grouping 502 can include an electrical component 510 for performing hybrid arbitration between the first application and the second application in response to determining that the first type and the second type cannot share the existing data session by selecting the first application or the second application to use the data connection based on a network policy in response to determining that the network policy specifies a difference in priority between the first type and the second type of application or service. In addition, logical grouping 502 can include an electrical component 512 for performing hybrid arbitration between the first application and the second application in response to determining that the first type and the second type cannot share the existing data session by selecting the first application or the second application to use the data connection based on a device policy in response to determining that the network policy does not specify a difference in priority between the first type and the second type of application or service. Additionally, system 500 can include a memory 520 that retains instructions for executing functions associated with electrical components 504-512. While shown as being external to memory 520, it is to be understood that one or more of electrical components 504-512 can exist within memory 520.

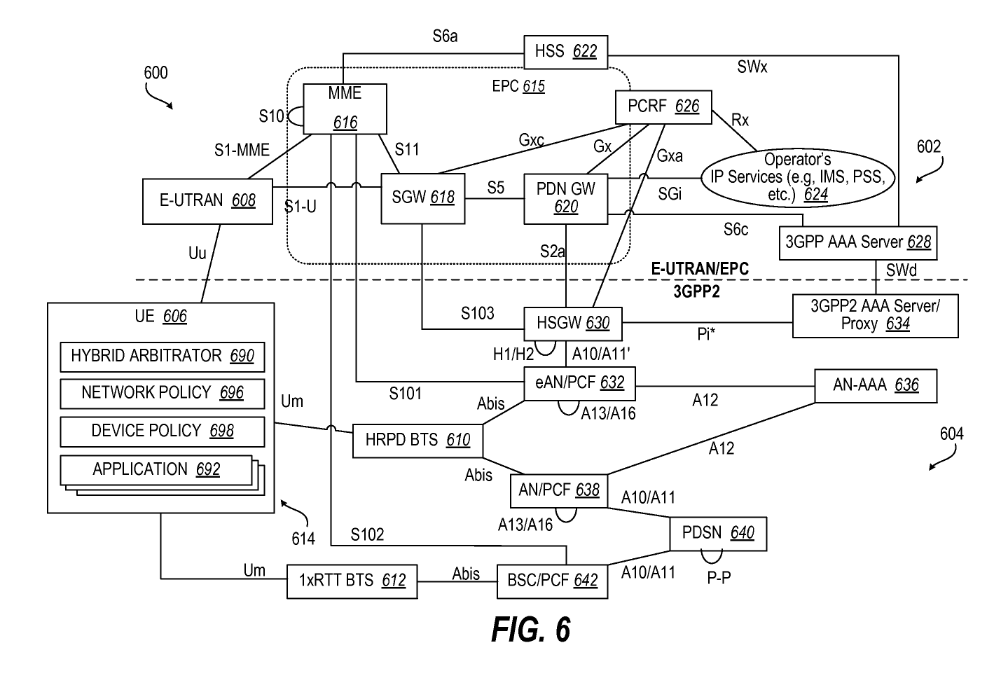

In FIG. 6, a communication system 600 is depicted with an Evolved Universal Terrestrial Radio Access Network (E-UTRAN)/Evolved Packet Core (EPC) 602 (i.e., GSM (Global System for Mobile Communications) or WCDMA (Wideband Code Division Multiple Access)) and a 3GPP2 network 604 for providing coverage to a mobile device implementing the apparatus and methods described herein, depicted as UE 606. The Third Generation Partnership Project 2 (3GPP2) is a collaboration between telecommunications associations to make a globally applicable third generation (3G) mobile phone system specification within the scope of the ITU's IMT-2000 project. In practice, 3GPP2 is the standardization group for CDMA2000, the set of 3G standards based on earlier 2G CDMA technology. 3GPP2 should not be confused with 3GPP, which specifies standards for another 3G technology known as Universal Mobile Telecommunications System (UMTS).

The LTE technology is a revolutionary upgrade of 3G systems including WCDMA and CDMA2000. The evolution path from 2G/3G systems to LTE is basically by realizing interworking and seamless handover between systems to migrate the existing network at a low cost. System Architecture Evolution (aka SAE) is the core network architecture of 3GPP's LTE wireless communication standard. SAE is the evolution of the General Packet Radio Service (GPRS) Core Network, with some differences: (1) simplified architecture; (2) All Internet Protocol Network (AIPN); and (3) support for higher throughput and lower latency radio access networks (RANs) support for, and mobility between, multiple heterogeneous RANs, including legacy systems as GPRS, but also non-3GPP systems (say WiMAX).

The evolved RAN for LTE consists of a single node, i.e., an evolved Base Node (“eNodeB” or “eNB”) that interfaces with a UE 606. The eNB is depicted as an E-UTRAN 608 for the E-UTRAN/EPC 602. The eNB hosts the PHYsical (PHY), Medium Access Control (MAC), Radio Link Control (RLC), and Packet Data Control Protocol (PDCP) layers that include the functionality of user-plane header-compression and encryption. It also offers Radio Resource Control (RRC) functionality corresponding to the control plane. It performs many functions including radio resource management, admission control, scheduling, enforcement of negotiated Uplink (UL) Quality of Service (QoS), cell information broadcast, ciphering/deciphering of user and control plane data, and compression/decompression of Downlink/Uplink (DL/UL) user plane packet headers.

Overall, three different Radio Access Technologies (RATs) are depicted for radio access to the UE 606. The E-UTRAN 608 has a Uu external radio interface (logical interface) to the UE 606. On the 3GPP2 network 604, both a HRPD Base Transceiver System (BTS) 610 and a 1xRTT (Radio Transmission Technology) BTS 612 can have a Um external radio interface to the UE 606. Examples are Uu or Um to the UE 606 for 3GPP systems and Um for 3GPP2 systems (i.e., CDMA). The external interface to the UE 606 transports user data and signaling data over an air interface 614.

The main component of the SAE architecture is the EPC 615, also known as SAE Core. The EPC 615 serves as equivalent of GPRS networks via subcomponents of a Mobility Management Entity (MME) 616, Serving Gateway (SGW) 618 and PDN Gateway (PGW) 620.

The MME 616 is the key control-node for the LTE access-network, depicted as the E-UTRAN 608. It is responsible for idle mode UE tracking and paging procedure including retransmissions. It is involved in the bearer activation/deactivation process and is also responsible for choosing the SGW 618 for a UE 606 at the initial attach and at time of intra-LTE handover involving Core Network (CN) node relocation. It is responsible for authenticating the user (by interacting with the Home Subscriber Server (HSS)). The Non-Access Stratum (NAS) signaling terminates at the MME 616 and it is also responsible for generation and allocation of temporary identities to UEs 606. It checks the authorization of the UE 606 to camp on the service provider's Public Land Mobile Network (PLMN) and enforces UE roaming restrictions. The MME 616 is the termination point in the network for ciphering/integrity protection for NAS signaling and handles the security key management. Lawful interception of signaling is also supported by the MME 616. The MME 616 also provides the control plane function for mobility between LTE and 2G/3G access networks with the S3 interface terminating at the MME 616 from the Serving GPRS Support Node (SGSN) (not depicted). The MME 616 also terminates the S6a interface towards the Home Subscriber Server (HSS) 622 for roaming UEs.

The SGW 618 routes and forwards user data packets, while also acting as the mobility anchor for the user plane during inter-eNodeB handovers and as the anchor for mobility between LTE and other 3GPP technologies (terminating S4 interface and relaying the traffic between 2G/3G systems and PGW). For idle state UEs 606, the SGW 618 terminates the Downlink (DL) data path and triggers paging when DL data arrives for the UE 606. It manages and stores UE contexts, e.g., parameters of the Internet Protocol (IP) bearer service, network internal routing information. It also performs replication of the user traffic in case of lawful interception.

The PGW 620 provides connectivity from the UE 606 to external packet data networks 624, depicted as Operator's IP Services, such as IP Multimedia Subsystem (IMS), Packet Switched Services (PSS) etc., by being the point of exit and entry of traffic for the UE 606. A UE 606 may have simultaneous connectivity with more than one PGW 620 for accessing multiple PDNs. The PGW 620 performs policy enforcement, packet filtering for each user, charging support, lawful Interception and packet screening. Another key role of the PGW 620 is to act as the anchor for mobility between 3GPP and non-3GPP technologies such as WiMAX and 3GPP2 (CDMA 1x and EvDO).

A key feature of the Evolved Packet System (EPS), otherwise referred herein as 3GPP Long Term Evolution (LTE), is the separation of the network entity that performs control-plane functionality (MME 616) from the network entity that performs bearer-plane functionality (SGW 618) with a well-defined open interface between them (S6). Since E-UTRAN 608 provides higher bandwidths to enable new services as well as to improve existing ones, separation of MME 616 from SGW 618 implies that SGW 618 can be based on a platform optimized for high bandwidth packet processing, whereas the MME 616 is based on a platform optimized for signaling transactions. This enables selection of more cost-effective platforms for, as well as independent scaling of, each of these two elements. Service providers can also choose optimized topological locations of SGWs 618 within the network independent of the locations of MMEs 616 in order to optimize bandwidth reduce latencies and avoid concentrated points of failure.

An Application Function (AF) is an element offering applications that require the Policy and Charging Control of traffic plane resources (e.g., UMTS Packet Switched (PS) domain/GPRS domain resources). The AF is depicted as an operator's IP services 624. One example of an application function is Policy Control and Charging Rules Function (PCRF) 626. The AF can use the Rx reference point to provide session information to the PCRF 626. The PCRF 626 is a functional element that encompasses policy control decision and flow based charging control functionalities. The PCRF 626 provides network control regarding the service data flow detection, gating, QoS and flow based charging (except credit management) towards the Policy and Charging Enforcement Function (PCEF) (not shown). The PCRF receives session and media related information from the AF and informs AF of traffic plane events. The PCRF 626 may check that the service information provided by the AF is consistent with the operator defined policy rules before storing the service information. The service information shall be used to derive the QoS for the service. The PCRF 626 may reject the request received from the AF and as a result the PCRF 626 indicates, in the response to the AF, the service information that can be accepted by the PCRF 626. The PCRF 626 may use the subscription information as basis for the policy and charging control decisions. The subscription information may apply for both session based and non-session based services. The subscription specific information for each service may contain e.g. max QoS class and max bit rate. If the AF requests it, the PCRF 626 reports IP-CAN (Internet Protocol Connectivity Access Network) session events (including bearer events and events on AF signaling transport) to the AF via the Rx reference point.

A 3GPP Authentication, Authorization, Accounting (AAA) server 628 is interfaced via an S6c to the PGW 620 and an SWx interface to the HSS 622.

S1-MME is the reference point for the control plane protocol between E-UTRAN 608 and MME 616. The protocol over this reference point is evolved Radio Access Network Application Protocol (eRANAP) and it uses Stream Control Transmission Protocol (SCTP) as the transport protocol.

S1-U reference point between E-UTRAN 608 and SGW 618 for the per-bearer user plane tunneling and inter-eNB path switching during handover. The transport protocol over this interface is GPRS Tunneling Protocol-User plane (GTP-U).

S2a provides the user plane with related control and mobility support between trusted non-3GPP IP access and the SGW 618. S2a is based on Proxy Mobile Internet Protocol (PMIP). To enable access via trusted non-3GPP IP accesses that do not support PMIP, S2a also supports Client Mobile Internet Protocol version 4 (IPv4) Foreign Agent (FA) mode.

S2b provides the user plane with related control and mobility support between evolved Packet Data Gateway (ePDG) and the PDN GW. It is based on PMIP.

S2c provides the user plane with related control and mobility support between UE and the PDN GW. This reference point is implemented over trusted and/or untrusted non-3GPP access and/or 3GPP access. This protocol is based on Client Mobile IP co-located mode.

S3 is the interface between SGSN (not shown) and MME 616 and it enables user and bearer information exchange for inter 3GPP access network mobility in idle or active state. It is based on Gn reference point as defined between SGSNs.

S4 provides the user plane with related control and mobility support between SGSN and the SGW 618 and is based on Gn reference point as defined between SGSN and Gateway GPRS Support Node (GGSN) (not shown).

S5 provides user plane tunneling and tunnel management between SGW 618 and PGW 620. It is used for SGW relocation due to UE mobility and if the SGW needs to connect to a non-collocated PDN GW for the required PDN connectivity.

S6a enables transfer of subscription and authentication data for authenticating/authorizing user access to the evolved system (AAA interface) between MME 616 and HSS 622.

S7 provides transfer of (QoS) policy and charging rules from Policy and Charging Rules Function (PCRF) 626 to Policy and Charging Enforcement Function (PCEF) in the PGW 620. This interface is based on the Gx interface.

S10 is the reference point between MMEs 616 for MME relocation and MME to MME information transfer.

S6 is the reference point between MME 616 and SGW 618.

SGi is the reference point between the PGW 620 and the packet data network 624.

Packet data network (PDN) 624 may be an operator-external public or private packet data network or an intra-operator packet data network, e.g. for provision of IMS services. This reference point corresponds to Gi for 2G/3G accesses Rx+. The Rx reference point resides between the Application Function and the PCRF 626.

The 3GPP2 network 604 is depicted as including a HSGW 630, evolved HRPD Access Network/Packet Control Function (eAN/PCF) 632, 3GPP2 AAA server/proxy 634, Access Node (AN)-AAA 636, AN/PCF 638, Packet Data Serving Node (PDSN) 640, and Base Station Controller (BSC)/PCF 642 in addition to the HRPD BTS 610 and 1xRTT BTS 612.

In the architecture, several new interfaces including S101, S103 and S2a are introduced to realize the interworking between CDMA2000 HRPD and LTE. Corresponding to the system architecture of LTE, Packet Data Serving Node (PDSN) is split into the HSGW 630 and PGW 620 while Access Network/Packet Control Function (AN/PCF) 638 is enhanced into eAN/PCF 632 to support the three new interfaces. HRPD here is called evolved HRPD (eHRPD).

The E-UTRAN and the 3GPP2 eHRPD network architecture includes the following interfaces:

S101 reference point provides for the signaling interface between the MME 616 in the 3GPP EPC 615 and the eAN/PCF 632 in the 3GPP2 eHRPD 604. This S101 reference point provides tunneling of signaling and data between the UE 606 and the target access network via the source/serving access network. This allows a UE 606 to tunnel HRPD air interface signaling over the LTE system to make pre-registration and exchange handover signaling messages with the target system before the actual handover, thus realizing a seamless and rapid handover between two systems.

S103 reference point is the bearer interface between the EPC Serving Gateway (SGW) 618 and the HSGW 630, which is used to forward the downlink data, minimizing the packet loss during the transfer from LTE to HRPD. The S103 reference point connects the PGW 620 in the 3GPP EPC 615 to the HSGW 630 in the 3GPP2 eHRPD network 604.

For the interworking between E-UTRAN/EPC 602 and 3GPP2 eHRPD network 604, the following reference points are defined:

The H1 reference point carries signaling information between a source HSGW (S-HSGW) and a target HSGW (T-HSGW) for optimized inter-HSGW handoff.

The H2 reference point carries user traffic between a source HSGW (S-HSGW) and a target HSGW (T-HSGW) for optimized inter-HSGW handoff.

The Gxa reference point connects the PCRF 626 in the 3GPP EPC 602 to Bearer Binding and Event Reporting Function (BBERF) in the HSGW 630 in the 3GPP2 eHRPD network 604.

The Pi* reference point connects the HSGW 630 to the 3GPP2 AAA server/proxy 634.

The S2a reference point connects the PGW 620 in the 3GPP EPC 615 to the HSGW 630 in the 3GPP2 eHRPD network 604. This reference point provides the user plane with related control and mobility support between eHRPD network 604 and the PGW 620. S2a provides the user plane with related control and mobility support between trusted non-3GPP IP access (e.g., WiMAX access network) and the 3GPP core network (PGW 620). It is defined between the Mobile Access Gateway and Packet Data Gateway. In the case that the Mobile IPv4 is used as S2a protocol, then the WiMAX side of this reference point is terminated by the MIPv4 Foreign Agent function.

S6b is the reference point between PGW 620 and 3GPP AAA server/proxy 634 for mobility related authentication if needed. S6b may also be used to retrieve and request storage of mobility parameters. This reference point may also be used to retrieve static QoS profile for a UE for non-3GPP access in case dynamic Policy and Charging Control (PCC) is not supported. Gx provides transfer of QoS policy and charging rules from PCRF 626 to Policy and Charging Enforcement Function (PCEF) in the PGW 620. Gxa provides transfer of QoS policy information from PCRF 626 to the trusted non- 3GPP accesses (e.g., Access Service Network (ASN) Gateway (GW)). Gxc provides transfer of QoS policy information from PCRF 626 to the SGW 618.

AN-AAA 636 communicates with the Radio Network Controller (RNC) (not shown) in the Access Network (AN) to enable authentication and authorization functions to be performed at the AN 632, 638. The interface between AN 632, 638 and AN-AAA 636 is known as the A12 interface.

HSGW 630 provides interconnection between UE 606 and the 3GPP EPS architecture, including seamless mobility, Policy and Charging Control (PCC) and roaming between LTE and HRPD. The HSGW 630 is the entity that terminates the eHRPD access network interface from the eAN/PCF 632 (i.e., A10/A6 interfaces). The HSGW 630 routes UE originated or UE terminated packet data traffic. HSGW 630 also establishes, maintains and terminates link layer sessions to UEs 606. The HSGW functionality provides interworking of the UE 606 with the 3GPP EPS architecture and protocols. This includes support for mobility, policy control and charging (PCC), access authentication, and roaming. The HSGW 630 supports inter-HSGW handoff as well, using S2a (Proxy Mobile Internet Protocol version 6 (PMIPv6))). The HSGW 630 supports inter-HSGW handoff with context transfer. The HSGW 630 may use inter-HSGW handoff without context transfer.

The eAN/PCF 632 supports the tunneling of HRPD air interface signaling through S101. The enhanced AN/PCF solution adds a Signaling Adaptation Protocol (SAP) in the connection layer.

A10/A6 interface bear the transmission of signaling and data between PCF and PDSN 640 for maintaining the Base Station System-Base Station Controller (BSS-BCF) A10 connection. The A10 interface bears data while A6 interface bears signaling.

Abis interface uses Abis protocol for interfaces between the BSC (not shown) and the BTS 610, 612. It consists of two parts on the application layer: control part (Abisc) and traffic part (Abist), the former converts the Um interface control channel signaling and the latter converts the control over the traffic channel.

The UE 606, which may be the same as or similar to UE 101 (FIG. 1), incorporates a hybrid arbitrator 690 that enables selective access to a data connection, either singularly or shared, for a plurality of applications 692. Arbitration is made between network policy (profiles) 696 and device policy (profiles) 698, which in an exemplary aspect give preference to the network policy 696 when the network policy indicates a difference in priority to contending applications and reverts to the device policy 698 when the contention is not resolved by the network policy.

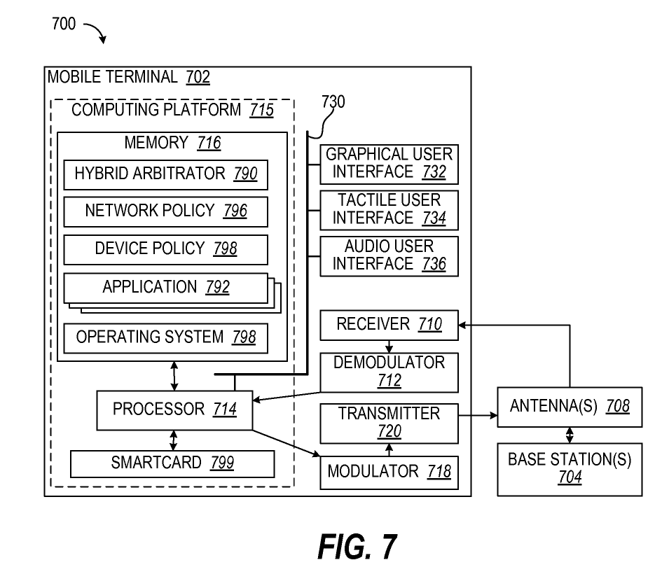

FIG. 7 is a block diagram of a system 700 that can be utilized to implement various aspects of the functionality described herein. In one example, system 700 includes a mobile terminal 702, which may be the same as or similar to UE 101 (FIG. 1). As illustrated, mobile terminal 702 can receive signal(s) from one or more base stations 704 and transmit to the one or more base stations 704 via one or more antennas 708. Additionally, mobile terminal 702 can comprise a receiver 710 that receives information from antenna(s) 708. In one example, receiver 710 can be operatively associated with a demodulator 712 that demodulates received information. Demodulated symbols can then be analyzed by a processor 714. Processor 714 of a computing platform 715 can be coupled to memory 716, which can store data and/or program codes related to mobile terminal 702. Additionally, mobile terminal 702 can employ processor 714 to perform methodologies described herein. Mobile terminal 702 can also include a modulator 718 that can multiplex a signal for transmission by a transmitter 720 through antenna(s) 708.

The computing platform 700 of the mobile terminal 702 incorporates a hybrid arbitrator 790 that enables selective access to a data connection, either singularly or shared, for a plurality of applications 792 that execute upon an operating system 794. Arbitration is made between network policy (profiles) 796 and device policy (profiles) 798, which in an exemplary aspect give preference to the network policy 796 when the network policy indicates a difference in priority to contending applications and reverts to the device policy 798 when the contention is not resolved by the network policy. In an aspect, for example, the network policy 796 can be loaded into resident or local device memory 716 from a removable card, such as a smartcard 799.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for integrating device policy and network policy for arbitrating data connection priority between packet data applications or services, the method comprising:
receiving a request, at a user equipment, for a data connection to a wireless network from a first application of a first type of application or service;
setting up a data session for the first application in response to determining that no other data session is in progress;
sharing an existing data session of a second application of a second type of application or service in response to determining that the first type and the second type can share the existing data session; and
performing hybrid arbitration between the first application and the second application in response to determining that the first type and the second type cannot share the existing data session, including:
selecting the first application or the second application to use the data connection based on a network policy in response to determining that the network policy specifies a difference in priority between the first type and the second type of application or service; and
selecting the first application or the second application to use the data connection based on a device policy in response to determining that the network policy does not specify a difference in priority between the first type and the second type of application or service.

2. The method of claim 1, further comprising performing hybrid arbitration at the user equipment according to a fixed network rule.

3. The method of claim 1, further comprising:
receiving a user input at the user equipment; and
creating a new device policy at the user equipment based upon the user input.

4. The method of claim 1, further comprising provisioning the user equipment with the network policy, prior to the performing of the hybrid arbitration, from at least one of a subscriber identification storage medium or an over-the-air transmission.

5. At least one processor for integrating device policy and network policy for arbitrating data connection priority between packet data applications or services, the at least one processor comprising:
a first module for receiving a request at a user equipment for a data connection to a wireless network from a first application of a first type of application or service;
a second module for setting up a data session for the first application in response to determining that no other data session is in progress;
a third module for sharing an existing data session of a second application of a second type of application or service in response to determining that the first type and the second type can share the existing data session; and
a fourth module for performing hybrid arbitration between the first application and the second application in response to determining that the first type and the second type cannot share the existing data session, including:
selecting the first application or the second application to use the data connection based on a network policy in response to determining that the network policy specifies a difference in priority between the first type and the second type of application or service; and
selecting the first application or the second application to use the data connection based on a device policy in response to determining that the network policy does not specify a difference in priority between the first type and the second type of application or service.

6. The at least one processor of claim 5, wherein the fourth module is further for performing the hybrid arbitration at the user equipment according to a fixed network rule.

7. The at least one processor of claim 5, further comprising a fifth module for receiving a user input at the user equipment, and for creating a new device policy at the user equipment based upon the user input.

8. The at least one processor of claim 5, further comprising a fifth module for provisioning the user equipment with the network policy, prior to performing the hybrid arbitration, from at least one of a subscriber identification storage medium or an over-the-air transmission.

9. A computer program product for integrating device policy and network policy for arbitrating data connection priority between packet data applications or services, the computer program product comprising:
a non-transitory computer-readable storage medium including stored sets of code comprising:
a first set of code for causing a computer to receive a request at a user equipment for a data connection to a wireless network from a first application of a first type of application or service;
a second set of code for causing the computer to set up a data session for the first application in response to determining that no other data session is in progress;
a third set of code for causing the computer to share an existing data session of a second application of a second type of application or service in response to determining that the first type and the second type can share the existing data session; and
a fourth set of code for causing the computer to perform hybrid arbitration between the first application and the second application in response to determining that the first type and the second type cannot share the existing data session including selecting the first application or the second application to use the data connection based on a network policy in response to determining that the network policy specifies a difference in priority between the first type and the second type of application or service, and selecting the first application or the second application to use the data connection based on a device policy in response to determining that the network policy does not specify a difference in priority between the first type and the second type of application or service.

10. The computer program product of claim 9, wherein the fourth set of code is further for performing the hybrid arbitration at the user equipment according to a fixed network rule.

11. The computer program product of claim 9, further comprising a fifth set of code for causing the computer to receive a user input at the user equipment and to create a new device policy at the user equipment based upon the user input.

12. The computer program product of claim 9, further comprising a fifth set of code for causing the computer to provision the user equipment with the network policy, prior to performing the hybrid arbitration, from at least one of a subscriber identification storage medium or an over-the-air transmission.

13. An apparatus for integrating device policy and network policy for arbitrating data connection priority between packet data applications or services, the apparatus comprising:
means for receiving a request at a user equipment for a data connection to a wireless network from a first application of a first type of application or service;
means for setting up a data session for the first application in response to determining that no other data session is in progress;
means for sharing an existing data session of a second application of a second type of application or service in response to determining that the first type and the second type can share the existing data session; and
means for performing hybrid arbitration between the first application and the second application in response to determining that the first type and the second type cannot share the existing data session, including:
means for selecting the first application or the second application to use the data connection based on a network policy in response to determining that the network policy specifies a difference in priority between the first type and the second type of application or service; and
means for selecting the first application or the second application to use the data connection based on a device policy in response to determining that the network policy does not specify a difference in priority between the first type and the second type of application or service.

14. The apparatus of claim 13, wherein the means for performing hybrid arbitration performs according to a fixed network rule.

15. The apparatus of claim 13, further comprising:
means for receiving a user input at the user equipment; and
means for creating a new device policy at the user equipment based upon the user input.

16. The apparatus of claim 13, further comprising means for provisioning the user equipment with the network policy, prior to performing the hybrid arbitration, from at least one of a subscriber identification storage medium or an over-the-air transmission.

17. A user apparatus for integrating device policy and network policy for arbitrating data connection priority between packet data applications or services, the user apparatus comprising:
a computing platform for receiving a request at a user equipment for a data connection to a wireless network from a first application of a first type of application or service;
a transceiver for setting up a data session for the first application in response to determining that no other data session is in progress;
the transceiver further for sharing an existing data session of a second application of a second type of application or service in response to the computing platform further determining that the first type and the second type can share the existing data session; and
a hybrid arbitrator for performing hybrid arbitration between the first application and the second application in response to determining that the first type and the second type cannot share the existing data session, including:
selecting the first application or the second application to use the data connection based on a network policy in response to determining that the network policy specifies a difference in priority between the first type and the second type of application or service; and
selecting the first application or the second application to use the data connection based on a device policy in response to determining that the network policy does not specify a difference in priority for the first type and the second type of application or service.

18. The user apparatus of claim 17, wherein the hybrid arbitrator is further for performing hybrid arbitration at the user equipment according to a fixed network rule.

19. The user apparatus of claim 17, further comprising user interface for receiving a user input at the user equipment, wherein the computing platform is further for creating a new device policy at the user equipment based upon the user input.

20. The user apparatus of claim 17, wherein the computing platform is further for provisioning the user equipment with the network policy, prior to performing the hybrid arbitration, from at least one of a subscriber identification storage medium or an over-the-air transmission via the transceiver.
